(19) United States
(12) Patent Application Publication
(10) Pub. No.: US 2011/0242524 A1
(43) Pub. Date: Oct. 6, 2011

(54) FLAT SURFACE INSPECTION APPARATUS

(75) Inventors: YUKI SHIMIZU, Yokohama (JP); Junguo Xu, Kasumigaura (JP); Shigeo Nakamura, Odawara (JP); Toshiyuki Nakao, Yokohama (JP); Toshihiko Nakata, Hiratsuka (JP); Toshifumi Honda, Yokohama (JP)

(73) Assignee: Hitachi, Ltd.

(21) Appl. No.: 13/007,433

(22) Filed: Jan. 14, 2011

(30) Foreign Application Priority Data
Mar. 30, 2010 (JP) 2010-076576

(51) Int. Cl. G01N 21/00

(52) U.S. Cl. 356/72; 33/556; 356/237.2

(57) ABSTRACT

An object is to provide a flat surface inspection apparatus that can prevent sliders from being damaged and detect micro defects. A flat surface inspection apparatus includes: a measured subject; a stage that supports the measured subject; a spindle that rotates the stage; a first part having light sources applying light beam onto the measured subject, a scattered-light-detecting section, a signal processing section that converts the scattered light into information about a first defect, and a first memory section that stores therein the information about the first defect; and a second part having sliders mounted with a contact sensor that detects a second defect smaller than the first defect, a loading/unloading mechanism that flies the slider over the measured subject, a slider control section that controls the loading/unloading mechanism based on the information about the first defects and second defects.

### BACKGROUND OF THE INVENTION

1. Field of the Invention

The present invention relates to a flat surface inspection apparatus for inspecting defects on flat surfaces.

2. Description of the Related Arts

With the development of industries, the level required for the techniques of detecting defects on flat surfaces is increasing year after year. For products for which flat surfaces are required, for example, semiconductor wafers before patterned and magnetic disks are named. Not a few defects exist on their surfaces. To inspect flat surfaces is an important process step in order to improve the reliability, performance, and yields of products to be fabricated using the flat surfaces.

For defects on flat surfaces, in semiconductor wafers, for example, the following is named: scratch marks and micro defects such as protrusions and holes produced in fabrication process steps of flat surfaces, and micro foreign substances attached to surfaces in fabrication process steps.

Further, on flat surfaces on which thin films are formed like magnetic disks, for example, flakes, portions without films, or the like to be produced in forming these thin films are also defects.

Regarding these defects, Japanese Patent Application Laid-Open Publication No. 2008-268189 discloses a method of detecting the scattering of light obliquely entered onto a flat surface to find defects. This method using light scattering allows the detection of defects in dimensions of a few nm to a few μm or above.

Now, it is known that the intensity I of scattered light that is generated when a laser beam is applied onto a defect has a relationship of I∝d̂6, where the particle size of a defect is d. In other words, because the scattered light generated is rapidly decreased as the size of defects becomes smaller, it is necessary to increase the scattered light generated from micro defects.

Furthermore, Japanese Patent Application Laid-Open Publication No. H08-167121 discloses a scheme in which a slider is flown over a rotating flat surface and the contact against this slider is detected for finding defects on the flat surface. As disclosed in Japanese Patent Application Laid-Open Publication No. H08-167121, for example, this scheme uses a slider mounted with a device, the resistance of which is changed because of contact heat, such as an MR device. Alternatively, as disclosed in Japanese Patent Application Laid-Open Publication No. S62-132282, the contact between a slider and a defect on a flat surface is detected using an acoustic emission device or the like. This scheme allows the detection of micro defects having a height up to about 4 nm.

Additionally, Japanese Patent Application Laid-Open Publication No. 2008-16158 discloses a scheme in which a heater included in a slider adjusts the flying height of the flying slider and a contact sensor is mounted near the lowest of the flying point of the slider for detecting micro defects having a height of 4 nm or below.

However, in the conventional techniques using optical schemes, for example, detection sensitivity can be improved by increasing laser power. However, the surface temperature at the laser beam applied portion on the flat surface rises to cause possible damages. Also, detection sensitivity can be improved by prolonging the time period for applying a laser beam. However, this causes a degradation of throughput because the inspectable area per unit time period is shrunk. Even though the above-mentioned schemes are combined for use, it is extremely difficult to inspect defects having a size of about 10 nm at high speed. Further, in the schemes using flying sliders, when defects on a flat surface of a measured subject are relatively large, these defects strongly collide against the air bearing surface of the slider or the contact sensor mounted on the slider to cause possible damages to the air bearing surface of the slider, the contact sensor itself, or the flat surface of the measured subject.

### SUMMARY OF THE INVENTION

The present invention has been made in view of the above-mentioned problems. It is an object thereof to provide a flat surface inspection apparatus that can prevent measured subjects and sliders from being damaged and detect micro defects.

In order to solve the above-mentioned problems, the present invention is a flat surface inspection apparatus including: a measured subject; a stage that supports the measured subject; a spindle that rotates the stage; a first part having at least a light source that applies a light beam onto the measured subject, a light detecting section that detects scattered light having reflected from the measured subject to convert the scattered light into a signal, a signal processing section that converts the scattered light having converted into the signal into information about a first defect, and a first memory section that stores therein the information about the first defect having converted at the signal processing section; and a second part having at least a slider mounted with a contact sensor that detects a second defect smaller than the first defect to convert the second defect into a signal, a loading/unloading mechanism that flies the slider over the measured subject, a slider control section that controls the loading/unloading mechanism based on the information about the first defect stored in the first memory section, a contact sensor signal processing section that converts the second defect having converted into the signal into information, and a second memory section that stores therein the information about the second defect having converted at the contact sensor signal processing section.

Further, the flat surface inspection apparatus includes: a plurality of the sliders; a slider scanning mechanism that allows the plurality of the sliders to perform a scan; and a plurality of slider fine moving mechanisms disposed between the sliders and the slider scanning mechanism, each of the slider fine moving mechanisms being provided for each of the plurality of the sliders to operate each of the sliders.

Furthermore, the slider control section controls the slider based on the information about the first defect such that the slider is moved in a radius direction of a flat surface of the measured subject or moved to outside the measured subject.

Furthermore, the flat surface inspection apparatus includes a stage/spindle control section that controls a number of revolutions of the spindle.

In addition, a flat surface inspection apparatus including: a measured subject; a stage that supports the measured subject; a spindle that rotates the stage; a stage/spindle control section that controls a number of revolutions of the spindle; a slider mounted with a contact sensor that detects a first defect and a second defect smaller than the first defect and converts the defects into signals; a loading/unloading mechanism that flies the slider over the measured subject; a slider control section that controls the loading/unloading mechanism based on information about the first defect stored in a first memory section; a contact sensor signal processing section that converts the first and second defects having converted into the signals into information; and a second memory section that stores therein the information about the second defect having converted at the contact sensor signal processing section, wherein the stage/spindle control section controls the spindle such that the number of revolutions of the spindle when the first defect is detected is increased more than the number of revolutions of the spindle when the second defect is detected.

Furthermore, the flat surface inspection apparatus includes: a plurality of the sliders; a slider scanning mechanism that allows the plurality of the sliders to perform a scan; and a plurality of slider fine moving mechanisms disposed between the sliders and the slider scanning mechanism, each of the slider fine moving mechanisms being provided for each of the plurality of the sliders to operate each of the sliders.

Furthermore, the slider control section controls the slider based on the information about the first defect such that the slider is moved in a radius direction of a flat surface of the measured subject or moved to outside the measured subject.

According to the present invention, it is made possible to provide a flat surface inspection apparatus that can prevent measured subjects and sliders from being damaged and detect micro defects.

### BRIEF DESCRIPTION OF THE INVENTION

The present invention will become fully understood from the detailed description given hereinafter and the accompanying drawings, wherein:

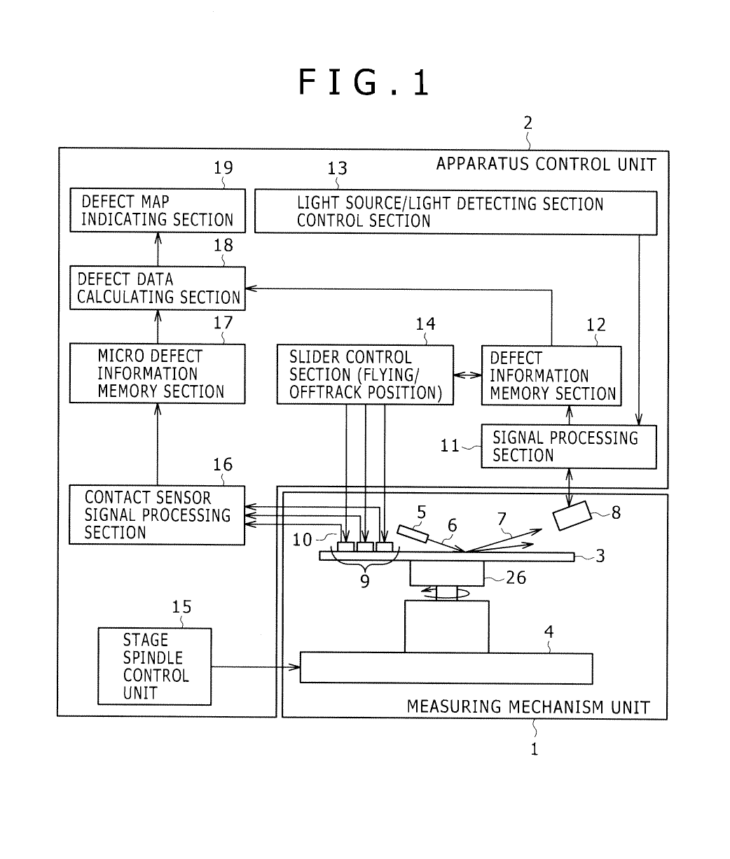

FIG. 1 is a schematic diagram depicting a flat surface inspection apparatus according to a first embodiment;

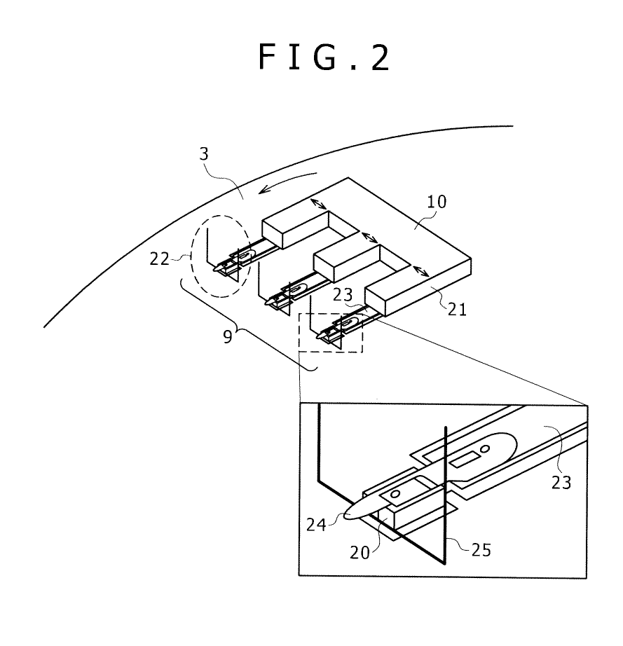

FIG. 2 is a schematic bird's eye view depicting a slider group formed of a plurality of sliders, which is a part of a mechanism configuring the flat surface inspection apparatus;

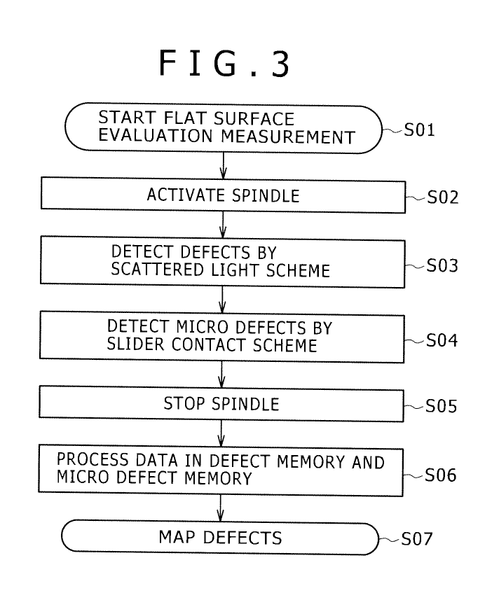

FIG. 3 is a flow chart schematically depicting the flat surface inspection apparatus according to the first embodiment when a flat surface is measured;

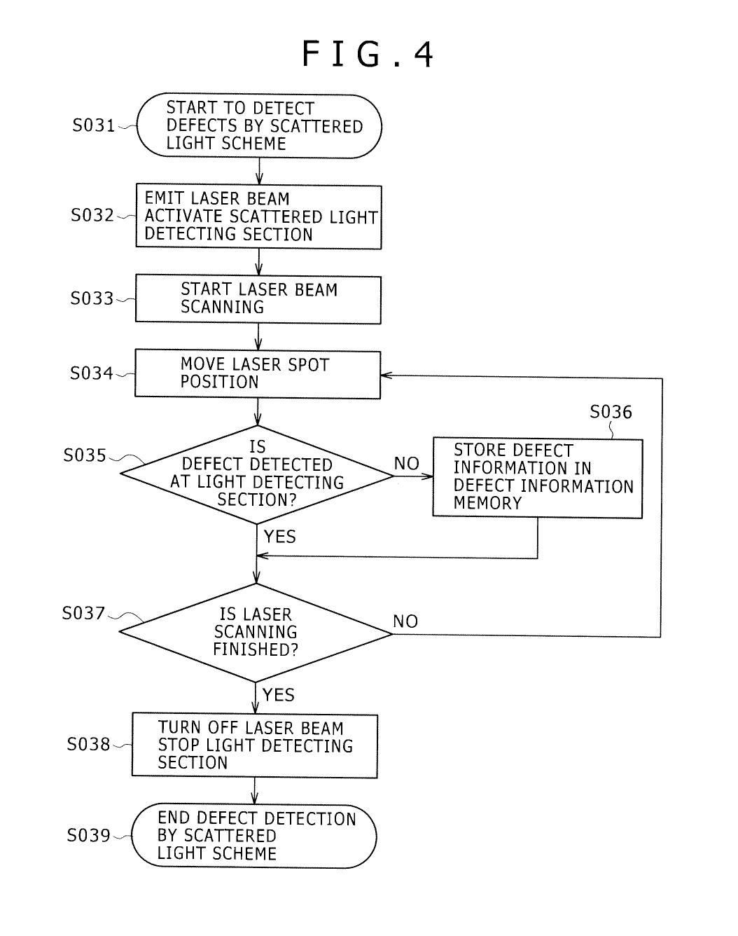

FIG. 4 is a flow chart depicting the case of detecting defects according to a scattered light scheme among flow charts when a flat surface is measured in the flat surface inspection apparatus according to the first embodiment;

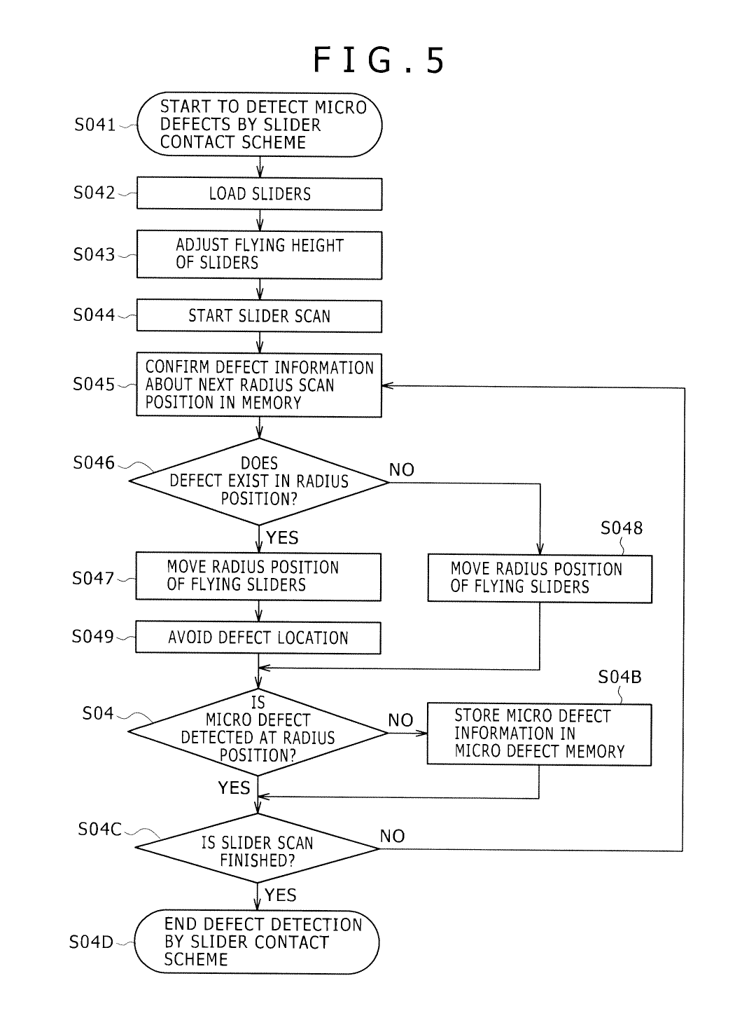

FIG. 5 is a flow chart depicting the case of detecting micro defects according to a slider contact scheme among flow charts when a flat surface is measured in the flat surface inspection apparatus according to the first embodiment;

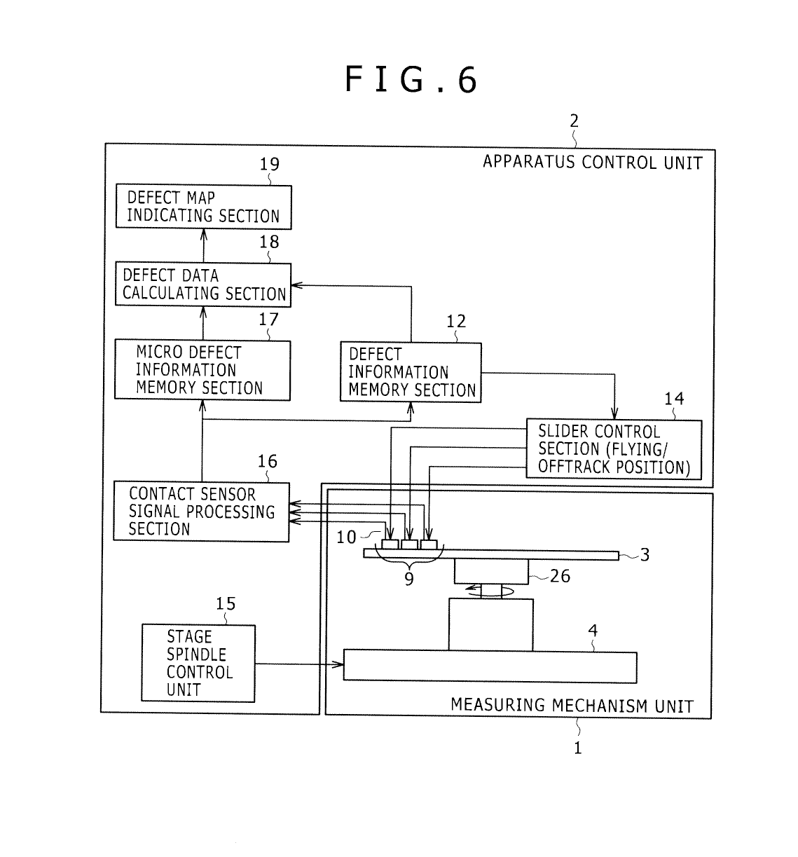

FIG. 6 is a schematic diagram depicting a flat surface inspection apparatus according to a second embodiment;

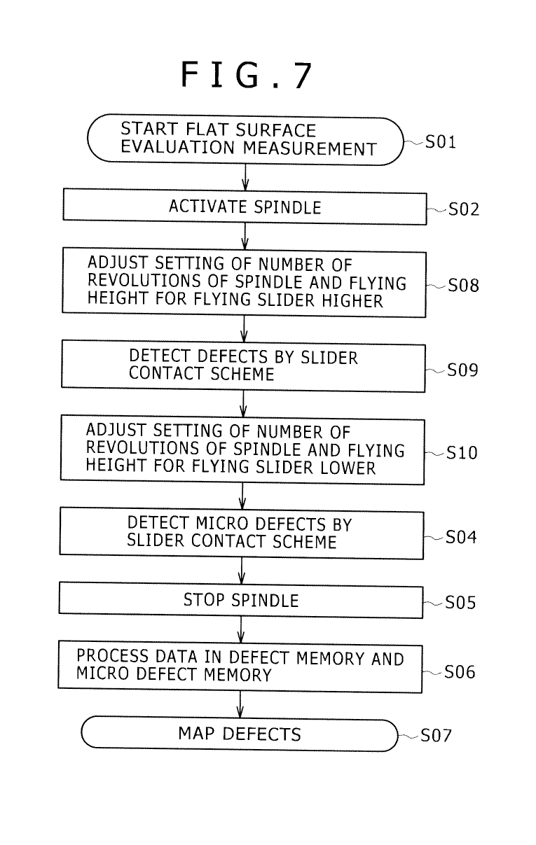

FIG. 7 is a flow chart schematically depicting the flat surface inspection apparatus according to the second embodiment when a flat surface is measured; and

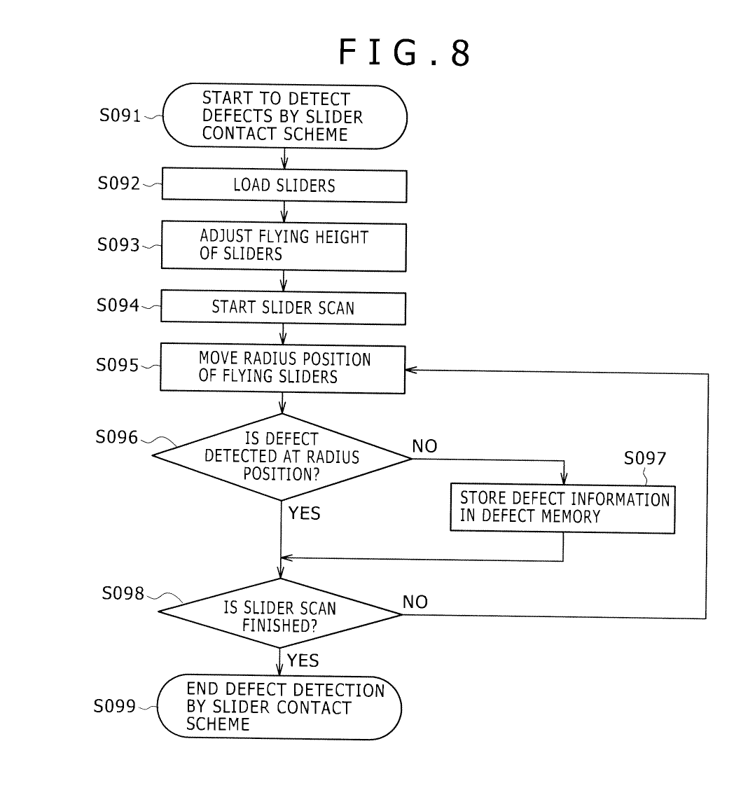

FIG. 8 is a flow chart depicting the case of detecting defects according to a slider contact scheme in flow charts when a flat surface is measured in the flat surface inspection apparatus according to the second embodiment.

### DETAILED DESCRIPTION OF THE PREFERRED EMBODIMENTS

In the following, embodiments will be described with reference to the drawings.

FIG. 1 is a schematic diagram depicting a flat surface inspection apparatus according to a first embodiment. The flat surface inspection apparatus according to the first embodiment is roughly categorized into a measuring mechanism unit 1 and an apparatus control unit 2.

The measuring mechanism unit 1 at least includes a stage 26 that supports a measured subject 3 having a flat surface, a spindle 4 that rotates the stage 26, a light source 5 used for detecting defects according to a scattered light scheme (in the first embodiment, for example, a laser light source is used), a light detecting section 8 that detects scattered light 7 of a light beam 6 (laser beam) from the light source 5 entering and reflecting from the flat surface, and a slider scanning mechanism 10 that allows the slider group 9 flying over the rotating flat surface to scan the flat surface. Further, not shown in the drawing, such a mechanism is provided that sequentially measures defects on the flat surface by relatively moving the light source 5, the light detecting section 8, and the slider group 9 over the flat surface.

In addition, desirably, a plurality of the light sources 5 and the light detecting sections 8 are disposed in consideration of measuring throughput, but single ones may be disposed. Also, desirably, for the number of sliders included in the slider group 9, multiple ones are disposed in consideration of measuring throughput, but a single one may be disposed. Furthermore, the light source 5 and the light detecting section 8 are configured as described in Japanese Patent Application Laid-Open Publication No. 2008-268189, for example.

The apparatus control unit 2 is configured of a first part directed to measurements according to the scattered light scheme, a second part directed to measurements according to a slider contact scheme, and a third part directed to a defect data mapping process.

The first part includes a signal processing section 11 that processes signals from the light detecting section 8 to convert the signals into information about the shape, size and the like of defects, a defect information memory section (first memory section) 12 that stores therein information obtained at the signal processing section 11 as defect information, a light source/light detecting section control section 13 that controls the light source 5 and the light detecting section 8, and other components.

The second part includes a slider control section 14 that a the flying height and offtrack position of the flying sliders and controls the slider scanning mechanism, a stage/spindle control section 15 that controls the number of revolutions of the spindle 4, a contact sensor signal processing section 16 that processes detection signals of defects detected by a contact sensor mounted on the slider, a micro defect information memory section (second memory section) 17 that stores therein information obtained at the contact sensor signal processing section 16 as micro defect information, and other components.

The third part includes a defect data calculating section 18 that integrates data of defects on the flat surface based on the information stored in the defect information memory section 12 and the micro defect information memory section 17, a defect map indicating section 19 that indicates a defect map based on data obtained at the defect data calculating section 18, and other components.

FIG. 2 is a schematic bird's eye view depicting the slider group 9 formed of a plurality of sliders, which is a part of the flat surface inspection apparatus.

The slider group 9 is used as mounted on the slider scanning mechanism 10. The slider scanning mechanism 10 has a coarse moving mechanism that moves the flat surface of the rotating measured subject 3 in the radius direction. Further, the slider scanning mechanism 10 has a slider fine moving mechanism 21 between the slider 20 and the slider scanning mechanism 10 to move the slider 20 in the radius direction order to avoid defects on the flat surface. Alternatively, the slider scanning mechanism 10 has a loading/unloading mechanism 22 as a mechanism that escapes the slider in the flying height direction in order to avoid defects on the flat surface. The slider fine moving mechanism 21 is formed of a displacement mechanism of a piezoelectric device, for example. Furthermore, for example, the loading/unloading mechanism 22 may be configured in such a way that a merge lip 24 at the tip end of a suspension 23 is moved above and below with a loading/unloading wire 25 to load and unload the slider 20. Also, desirably, the slider group 9 includes a function that applies electric power to a heater (not shown) mounted on the slider 20 for adjusting the flying height of the slider, a mechanism that is capable of adjusting the flying height of the slider 20, and a mechanism that senses the contact between defects on the flat surface and the slider. Further, desirably, the flying height of the slider 20 is kept constant when the slider 20 is allowed to scan the rotating flat surface. For example, it is sufficient that the number of revolutions of the flat surface is adjusted in accordance with the radius of the flying slider 20 (the distance between the center of the measured subject 3 and the slider) and a circumferential velocity is kept constant at the radius of the flying slider 20. Alternatively, when the number of revolutions of the flat surface is set constant not depending on the radius of the flying slider 20, it is sufficient to adjust electric power to be applied to the heater for adjusting the flying height of the slider. This heater for adjusting the flying height of the slider is mounted on each slider. In addition, desirably, a plurality of the sliders are flown at the same time for measuring the rotating flat surface in order to improve measuring throughput. In this case, because a plurality of the sliders are flown under the conditions of different circumferential velocities, desirably, the heater for adjusting the flying height of the slider is used to make the flying height of each slider almost constant.

FIG. 3 shows a flow chart when the flat surface inspection apparatus according to the first embodiment inspects flat surfaces. This flow chart includes seven steps roughly categorized from the start of the evaluation measurement of a flat surface (Step S01) to defect mapping (Step S07). FIG. 4 shows a flow chart depicting the detail of defect detection (Step S03) according to the scattered light scheme among the operations of the flow chart shown in FIG. 3. FIG. 5 shows a flow chart depicting the detail of micro defect detection (Step S05) according to the slider contact scheme in the flow chart shown in FIG. 3.

The flat surface inspection by the flat surface inspection apparatus according to the first embodiment will be described with reference to FIGS. 1 to 5.

First, the measured subject 3 is mounted on the spindle 4 of the flat surface inspection apparatus, and the evaluation measurement of a flat surface is started (Step S01). Here, the method of holding the measured subject 3 with the spindle 4 may be a vacuum chuck, for example. The spindle 4 is activated (Step S02), the stage/spindle control section 14 adjusts the number of revolutions of the spindle 4 to a predetermined number of revolutions, and then defect detection is performed according to the scattered light scheme (Step S03). In the scattered light scheme, relatively large defects (first defects) are to be detected.

After the defect detection is started according to the scattered light scheme (Step S031), the light source 5 is activated to emit a laser beam as well as the light detecting section 8 is activated (Step S032). After that, the emission of the laser beam is stabilized, and then laser beam scanning is started for the flat surface of the measured subject 3 (Step S033). A laser spot is moved in the radius direction of the rotating flat surface while the light detecting section 8 monitors the scattered light 7 from the flat surface (Step S034). Here, when it is determined that a defect exists on the flat surface in the consequence of processing the output of the light detecting section 8 at the signal processing section 11 (Step S035), information about the position, shape, size, and the like of the defect on the flat surface is stored in the defect information memory section 12 (Step S036). These operations of light beam scanning and defect detection are repeated until laser scanning is finished (Step S037). When this laser scanning is finished, the laser beam is turned off and the light detecting section 8 is stopped (Step S038), and then the defect detection according to the scattered light scheme is ended (Step S039).

After the defect detection is performed according to the scattered light scheme (Step S03), micro defects (second defects) are to be detected according to the slider contact scheme.

After micro defect detection is started according to the slider contact scheme (Step S041), the loading/unloading mechanisms 22 are used to load the sliders 20 over the flat surface of the rotating measured subject 3 (Step S042). After that, the slider control section 14 is used to adjust the flying height of the sliders 20 (Step S043). Then, a scan performed by the slider group 9 is started in the radius direction of the rotating flat surface (Step S044). At this time, before the sliders are moved in the radius direction, the defect information stored in the defect information memory section 12 is confirmed whether any defects exist at the subsequent radius position (Step S045). When it is determined that a defect exists at this radius position as the result of confirmation (Step S046), the sliders are moved to this radius position (Step S047), and then micro defect detection is performed at this radius position while the slider fine moving mechanisms 21 or the loading/unloading mechanisms 22 are used to operate the sliders for avoiding the defect at the location at which the defect exists. When it is determined that no defect exists at this radius position (Step S046), the sliders are moved to this radius position (Step S048), and micro defect detection is performed at this radius position. Here, when it is determined that a micro defect is detected with the sliders 20 at this radius position based on the output from the contact sensor signal processing section 16 (Step S04A), information about the location, size, and the like of this micro defect on the flat surface is stored in the micro defect information memory section 17 (Step S04B). Particularly, when no micro defect is detected, the operations from Steps S045 to S04B are repeated until the scan performed by the sliders 20 is finished (Step S04C). After the slider scan is finished, the defect detection according to the slider contact scheme is ended (Step S04D).

In addition, now, for the operation of avoiding contacting against relatively large defects, for example, the head is unloaded from the location of a defect before the sliders 20 are flown. Alternatively, before passing the location of the defect, the sliders 20 may be moved in the offtrack direction (outside the measured subject 3) for avoidance. When there is a sufficient travel for adjusting the flying height of the sliders 20, the flying height of the sliders 20 may be adjusted to avoid contact before passing the location of a defect.

With these operations, micro defects, which cannot be detected according to the scattered light scheme, are detected by allowing the slider 20 to perform a scan in the radius direction of the rotating flat surface while avoiding contacting against relatively large defects, and information about the height and locations of defects is then stored in the micro defect information memory section 17.

At this time, it is made possible to highly accurately detect the height of micro defects by repeating scans as the flying height of the sliders 20 is changed. In addition, in order to eliminate damages to the contact sensors, the air bearing surfaces of the sliders 20, or the flat surface of the measured subject 3, which are caused in association with a strong contact against defects, information about the height and locations of defects is stored in the micro defect information memory section 17 as the flying height of the sliders 20 is lowered step by step. For the locations at which defects exist, it is a good way that smaller micro defects are searched while the avoiding operation is performed so as not to fly the sliders 20 so high and information about the detected micro defect is added to the micro defect information memory section 17.

Further, for the micro defect detection according to the slider contact scheme, when the operations from Steps S044 to S04C are repeated as the flying height of the sliders 20 is lowered step by step, it is made possible to estimate the height of micro defects based on the flying height of the sliders 20. In this case, it is made possible to obtain information about the distribution of micro defect height in mapping defects, from information about the height of micro defects stored in the micro defect information memory section 17.

After the defect detection performed according the slider contact scheme (Step 204), the spindle 4 is stopped (Step S05). After that, based on the defect information obtained by measurements according to the scattered light scheme in Step S03, which is stored in the defect information memory section 12, and the micro defect information obtained according to the slider contact scheme in Step S04, which is stored in the micro defect information memory section 17, data is processed by the defect data calculating section 18 (Step S06). Finally, information resulting from calculations is used to indicate the result of the detected defects on the flat surface (Step S07). As discussed above, the evaluation measurement of the flat surface is ended.

After the measurements according to the scattered light scheme and the slider contact scheme, calculations are performed based on the defect information stored in the defect information memory section 12 and the micro defect information memory section 17 for creating a distribution map of the defects on the flat surface. It may be possible that after this distribution map is created, defect portions are marked for easy identification of the locations at which defects exist in later inspections, depending on uses.

As discussed above, according to the first embodiment, relatively large defects (first defects) are detected in advance according to the scattered light scheme, whereby it is made possible to detect micro defects according to the slider contact scheme as the collision of relatively large defects against the flying slider is prevented based on the stored defect information when micro defects (second defects) are subsequently detected according to the slider contact scheme. Here, first defects are larger than second defects, and their diameters are about 20 nm or larger. On this account, micro defects can be highly accurately detected while the flat surface, the defects on the flat surface, and the flying sliders are prevented from being damaged.

In addition, in the first embodiment, the result of the detected defects on the flat surface is indicated after all the measurements are finished. However, it may be possible that the result of the detected defects is sequentially indicated when information about defects and micro defects is stored in Step S036 or S04B, for example.

Further, in the first embodiment, micro defect detection is performed according to the slider contact scheme after the entire surface of the measured subject is measured according to the scattered light scheme. However, it may be possible to concurrently perform these two schemes. In this case, however, the apparatus and the measuring sequences are configured such that the areas to be measured according to the slider contact scheme are measured in advance according to the scattered light scheme.

Furthermore, in the case in which the slider group 9 includes a single slider, when the slider is moved to perform a scan in the radius direction of the rotating flat surface, it is necessary to keep the relative velocity between the flat surface of the measured subject 3 and the slider constant all the time in order to maintain the flying height of the slider constant. To this end, with the use of the stage/spindle control section 15 to control the number of revolutions of the flat surface of the measured subject 3, that is, the number of revolutions of the spindle 4, it is made possible that the flying height of the slider is kept constant more accurately with no necessity to adjust the flying height of the slider. In this case, the stage/spindle control section 15 controls the number of revolutions of the spindle 4 such that the number of revolutions of the spindle 4 is reduced as the slider goes from the center of the measured subject 3 to the outer circumferential side.

Next, a second embodiment will be described with reference to FIG. 6.

FIG. 6 is a schematic diagram depicting a flat surface inspection apparatus according to the second embodiment. Similarly to the first embodiment, the flat surface inspection apparatus according to the second embodiment is roughly categorized into a measuring mechanism unit 1 and an apparatus control unit 2.

The measuring mechanism unit 1 mainly includes a spindle 4 that rotates a measured subject 3 having a flat surface, a slider scanning mechanism 10 that allows a slider group 9 flying over the rotating flat surface to scan the flat surface, and other components. The second embodiment is different from the first embodiment in that an optical system used for the scattered light scheme is not mounted.

In addition, desirably, although a plurality of sliders are included in the slider group 9 in consideration of measuring throughput, a single slider may be disposed.

The apparatus control unit 2 is formed of a first part directed to measurements according to the slider contact scheme, and a second part directed to a defect data mapping process.

The first part includes a slider control section 14 that adjusts the flying height and offtrack position of the flying sliders and controls the slider scanning mechanism 10, a stage/spindle control section 15 that controls the number of revolutions of the spindle 4, a contact sensor signal processing section 16 that processes defect detection signals from a contact sensor mounted on the slider, a defect information memory section 12 that stores therein information obtained at the contact sensor signal processing section 16 as defect information, a micro defect information memory section 17 that stores therein the above-mentioned information as micro defect information, and other components.

The second part includes a defect data calculating section 18 that integrates data of defects on the flat surface based on the information stored in the defect information memory section 12 and in the micro defect information memory section 17, a defect map indicating section 19 that indicates a defect map based on obtained at the defect data calculating section 18, and other components.

In addition, the configurations of the slider group 9 and the slider scanning mechanism 10 of this embodiment are the same as those in the first embodiment.

FIG. 7 is a flow chart when a flat surface is inspected by the flat surface inspection apparatus according to the second embodiment. The difference from the flow chart when a flat surface is inspected in the first embodiment shown in FIG. 3 is in that the operation of detecting defects according to the scattered light scheme (Step S03) is replaced by the defect detection according to the slider contact scheme (Step S09). With this replacement, newly added is control over the number of revolutions of the spindle 4 for adjusting the flying height of the sliders higher (Steps S08 and S10).

In the second embodiment, the detection of first defects is performed instead of the scattered light scheme by setting an increased number of revolutions of the spindle 4 to adjust the flying height of the sliders higher.

FIG. 8 is a flow chart when defect detection is performed according to the slider contact scheme in the second embodiment instead of the scattered light scheme in the first embodiment by setting an increased number of revolutions of the spindle to adjust the flying height of the sliders higher. Information about defects obtained as the flying height of the sliders is set higher is stored in the defect information memory section 12

The other apparatus configurations and operation flows are the same as those in the first embodiment. Based on information about defects obtained as an increased number of revolutions of the spindle 4 is set to adjust the flying height of the sliders higher and information about micro defects obtained as the number of revolutions of the spindle is returned to the original setting to adjust the flying height of the sliders lower, the defect data calculating section 18 processes data (Step S06), and finally, the result of the detected defects on the flat surface is indicated using information resulting from calculations (Step S07). With the operations above, the evaluation measurement of the flat surface is ended.

For detailed explanations, in the flat surface inspection apparatus according to the second embodiment, first, in the state in which an increased number of revolutions of the flat surface is set to adjust the flying height of the sliders higher, the sliders are moved to perform a scan in the radius direction of the flat surface, and relatively large defects (first defects) on the flat surface are detected according to the slider contact scheme. The dimensions, shapes, and locations of the detected defects on the flat surface are stored in the defect information memory section 12. In addition, when the flying height of the sliders is set higher, it may be possible that a load applied onto the sliders is reduced to set the flying height higher, instead of setting an increased number of revolutions of the flat surface.

Subsequently, the number of revolutions of the flat surface is set smaller than that in the above-mentioned defect measurement, the sliders are moved to perform a scan in the radius direction of the flat surface as the flying height of the sliders is lowered, and micro defects on the flat surface are detected (second defects). At this time, the defect information stored in the defect information memory section 12 is utilized to prevent the sliders from flying so much above at the locations at which defects exist. With this operation, it is made possible to prevent the contact sensors mounted on the sliders from strongly contacting against defects, and to eliminate damages to the contact sensors, the air bearing surfaces of the sliders, or the flat surface of the measured subject in association with this contact.

In the flat surface inspection apparatus according to the second embodiment, after measurements according to the slider contact scheme, calculations are performed based on the defect information stored in the defect information memory section 12 and the micro defect information memory section 17, and a distribution map of defects on the flat surface is created. It may be possible that after this distribution map is created, defect portions are marked for easy identification of the locations at which these defects exist in later inspections.

In addition, here, in the second embodiment, the flying height of the sliders is set higher depending on the settings of the number of revolutions of the disk. However, for example, it may be possible that the flying height of the sliders is set higher by slightly shifting the slider scanning mechanism in the direction toward outside the flat surface to reduce a load applied from the suspension 23 to the slider 20.

As discussed above, the first and second embodiments are described. For example, the flat surface inspection apparatuses of these embodiments may be applied to the measurements of the surfaces of magnetic disks and semiconductor wafers. Further, for control methods of the flying height of the sliders, the flying height may be controlled by piezoelectric elements or the like. Furthermore, in order to more surely sense the contact between the slider and the flat surface, a plurality of contact sensors may be disposed.

What is claimed is:

1. A flat surface inspection apparatus comprising:
a measured subject;
a stage that supports the measured subject;
a spindle that rotates the stage;
a first part having at least
a light source that applies a light beam onto the measured subject,
a light detecting section that detects scattered light having reflected from the measured subject to convert the scattered light into a signal,
a signal processing section that converts the scattered light having converted into the signal into information about a first defect, and
a first memory section that stores therein the information about the first defect having converted at the signal processing section; and
a second part having at least
a slider mounted with a contact sensor that detects a second defect smaller than the first defect to convert the second defect into a signal,
a loading/unloading mechanism that flies the slider over the measured subject,
a slider control section that controls the loading/unloading mechanism based on the information about the first defect stored in the first memory section,
a contact sensor signal processing section that converts the second defect having converted into the signal into information, and
a second memory section that stores therein the information about the second defect having converted at the contact sensor signal processing section.

2. The flat surface inspection apparatus according to claim 1, further comprising:
a plurality of the sliders;
a slider scanning mechanism that allows the plurality of the sliders to perform a scan; and
a plurality of slider fine moving mechanisms disposed between the sliders and the slider scanning mechanism, each of the slider fine moving mechanisms being provided for each of the plurality of the sliders to operate each of the sliders.

3. The flat surface inspection apparatus according to claim 1, wherein the slider control section controls the slider based on the information about the first defect such that the slider is moved in a radius direction of a flat surface of the measured subject or moved to outside the measured subject.

4. The flat surface inspection apparatus according to claim 1, further comprising a stage/spindle control section that controls a number of revolutions of the spindle.

5. A flat surface inspection apparatus comprising:
a measured subject;
a stage that supports the measured subject;
a spindle that rotates the stage;
a stage/spindle control section that controls a number of revolutions of the spindle;
a slider mounted with a contact sensor that detects a first defect and a second defect smaller than the first defect and converts the defects into signals;
a loading/unloading mechanism that flies the slider over the measured subject;
a slider control section that controls the loading/unloading mechanism based on information about the first defect stored in a first memory section;
a contact sensor signal processing section that converts the first and second defects having converted into the signals into information; and
a second memory section that stores therein the information about the second defect having converted at the contact sensor signal processing section,
wherein the stage/spindle control section controls the spindle such that the number of revolutions of the spindle when the first defect is detected is increased more than the number of revolutions of the spindle when the second defect is detected.

6. The flat surface inspection apparatus according to claim further comprising:
a plurality of the sliders;
a slider scanning mechanism that allows the plurality of the sliders to perform a scan; and
a plurality of slider fine moving mechanisms disposed between the sliders and the slider scanning mechanism, each of the slider fine moving mechanisms being provided for each of the plurality of the sliders to operate each of the sliders.

7. The flat surface inspection apparatus according to claim 5, wherein the slider control section controls the slider based on the information about the first defect such that the slider is moved in a radius direction of a flat surface of the measured subject or moved to outside the measured subject.
